(19) United States
(12) Patent Application Publication
(10) Pub. No.: US 2015/0355645 A1
(43) Pub. Date: Dec. 10, 2015

(54) Pressure Build-up Valve

(71) Applicant: President Engineering Group Limited, Sheffield (GB)

(72) Inventors: Gilbert Marangwanda, Huddersfield (GB); Daniel Williams, Sheffield (GB); James Kevin Fretwell, Sheffield (GB)

(21) Appl. No.: 14/299,180

(22) Filed: Jun. 9, 2014

(51) Int. Cl. G05D 16/06

(52) U.S. Cl. CPC G05D 16/0672

(57) ABSTRACT

A pressure build-up valve is disclosed which has heightened sensitivity and reduced overall valve size and is adapted to minimize pressure fall-off and to be mounted to a pressurized vessel storing a gas or a liquid. The value is particularly, although not exclusively, designed to build and maintain pressure in cryogenic transportation trailer and storage tanks and is primarily for use with a closed loop liquefied natural gas fluid control system.

### FIELD OF THE INVENTION

The present invention relates to a pressure build-up valve.

### BACKGROUND OF THE INVENTION

Pressure build-up valves function to control the build-up of pressure in a controlled environment. The pressure is relieved by allowing the pressurized substance to flow out of the system by an alternative means when the valve is open. A typical pressure build-up valve comprises: at least one gas or liquid containing chamber, a movable valve member, a pressure responsive contractible element and a bonnet.

Prior art pressure build-up valves are known in which a pressure responsive contractible element comprises a set of bellows, for example Howlett (U.S. Pat. No. 2,965,121, 1960). The bellows provides a pressure response valve which combines the functions of a pressure-closing valve with the functions of a pressure-opening valve. However, recent known problems with pressure build up valves include a poor level of sensitivity as identified by McManigal in (U.S. Pat. No. 5,186,209, 1993). Furthermore, in pressure build-up applications a correlation is evident whereby the size of the pressure responsive contractible elements usually determines the sensitivity of the valve to perform pressure control.

### SUMMARY OF THE INVENTION

The present invention relates to a pressure build-up valve adapted to minimize pressure fall-off and to be mounted to a pressurized vessel storing a gas or a liquid. The valve is particularly, although not exclusively, designed to build and maintain pressure in cryogenic transportation trailer and storage tanks and is primarily for use with a closed loop liquefied natural gas (LNG) fluid control system. As a liquid or gas is drawn from a closed loop fluid control system, the pressure inside the system will fall. To compensate for this, the pressure build-up valve will open to allow liquid to pass through a pressure build-up coil, restoring the system to its normal working pressure.

The flow of fluid is governed by the pressure differential created by the liquid head within a trailer or storage tank. The maximum pressure differential can be achieved in a storage tank which can accommodate LNG to a height of 10 m, giving a corresponding pressure of 6.5 PSI. This low pressure differential accommodates low flow velocities and Low Reynolds number flow with low pressure fluctuations and has allowed the pressure build-up valve to be designed with a unique pressure sensing mechanism allowing for significantly low spring rates to be used for the pressure setting spring.

It is an object of the current invention to provide a pressure build-up valve which is capable of delivering increased sensitivity in combination with a reduced valve size. This is achieved by the inclusion of a preset spring rate which enables the size of the valve to be reduced and heightens the sensitivity of the valve in comparison to the prior art.

According to a first aspect of the present invention, there is provided a pressure build-up valve comprising: a valve body having an inlet and an outlet; a valve bonnet and adjusting means mounted thereon; a pressure chamber housing; a pressure chamber and a relief chamber; a movable valve seat; a piston; a first resilient biasing means having a preset spring rate and located adjacent to said piston and adjacent to the a second resilient biasing means; a second resilient biasing means having one end abutting the valve seat and an opposed end abutting the adjusting means; said first and second resilient biasing means being arranged in series and configured to operate in parallel; whereby, in response to a drop in pressure within the valve, the guide piston is lowered relieving pressure on the first resilient biasing means, causing it to expand; the expanded first resilient biasing means biases the second resilient biasing means to open the valve and divert the flow of fluid from the pressure chamber into the relief chamber. As such, the valve is closed, and will only open once the pressure in the system returns to its normal working pressure.

In response to an increase in pressure within the valve, the guide piston is elevated by the liquid head within the valve compressing the first resilient biasing means; the compressed first resilient biasing means biases the second resilient biasing means to close the valve and prevent the flow of fluid from the pressure chamber into the relief chamber.

Preferably the pressure build-up valve is for use in cryogenic transportation trailer and storage tanks; for use with a closed loop liquefied natural gas (LNG) fluid control system.

Preferably the second resilient biasing means is a bellows with a preset spring rate in the range of 30-41 N/mm.

Preferably, the pressure chamber housing has an upper and lower portion and a plurality of cylindrical apertures arranged circumferentially around said lower portion.

Preferably, said pressure build-up valve inlet and outlet has standard butt weld ends allowing for easy welding onto flanges and directly onto piping.

Other aspects are as set out in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1: is a perspective view of a pressure build-up valve in accordance with a preferred embodiment of the present invention;

FIG. 2: is a cross sectional cutaway view of the pressure build-up valve, in accordance with a preferred embodiment of the present invention;

FIG. 3: is an enlarged perspective view of the lower portion of the pressure build-up valve in accordance with a preferred embodiment of the present invention;

FIG. 4: is an enlarged view of the pressure chamber housing, attached to the guide piston, in accordance with a preferred embodiment of the present invention in an open position;

FIG. 5: is a cross sectional cut away view of the lower portion of the pressure build-up valve, in accordance with a preferred embodiment of the present invention in an open position;

FIG. 6: is a cross sectional cut away view of the lower portion of the pressure build-up valve, in accordance with a preferred embodiment of the present invention in a closed position; and

FIG. 7: is a view of some of the individual components of the pressure build-up valve.

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

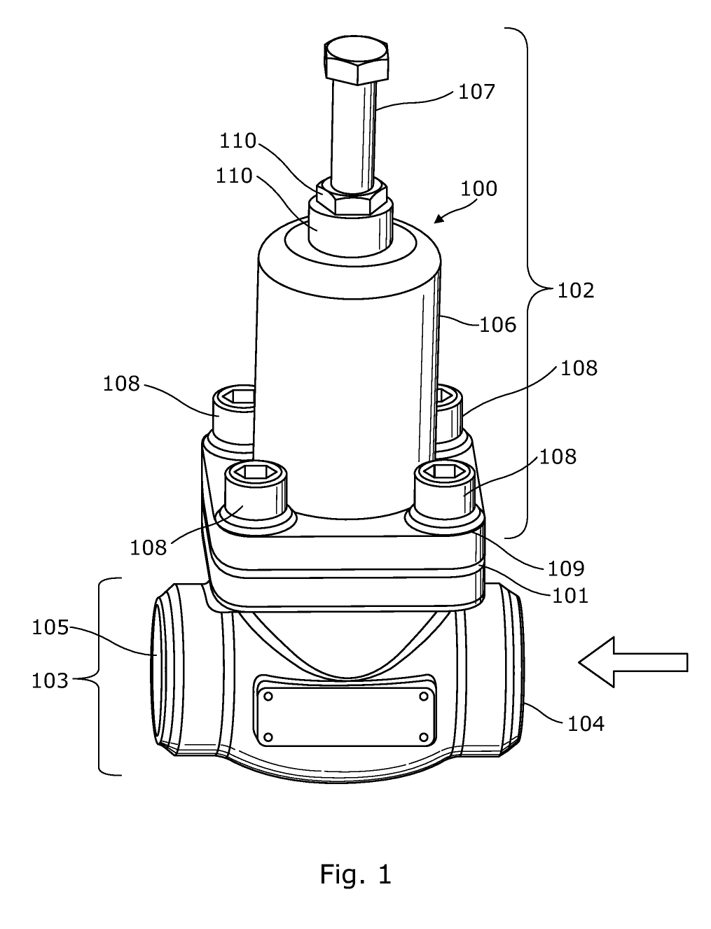

Referring to FIG. 1 herein there is illustrated a perspective view of a pressure build-up valve 100 in accordance with a preferred embodiment of the present invention. Said pressure build-up valve comprises a main body plate 101 having an upper part 102 and a lower part 103 and having an inlet 104 and an outlet 105 defined therein; a hollow substantially cylindrical bonnet 106, which is fitted to the upper part 102 of main body 101; a set pressure adjusting screw 107, rotatable about an axis and mounted on an upper part of the bonnet 106; said upper part 102 and lower part 103 being connected by four threaded bolts 108 and washers, which extend longitudinally through a plurality of apertures 109 in the respective upper and lower parts 102 and 103. Preferably, the bonnet 106 is of phosphor bronze, and the pressure adjusting screw 107, four threaded bolts 108 and washers are of stainless steel. The pressure adjusting screw is secured to the bonnet housing via two stainless steel nuts (110).

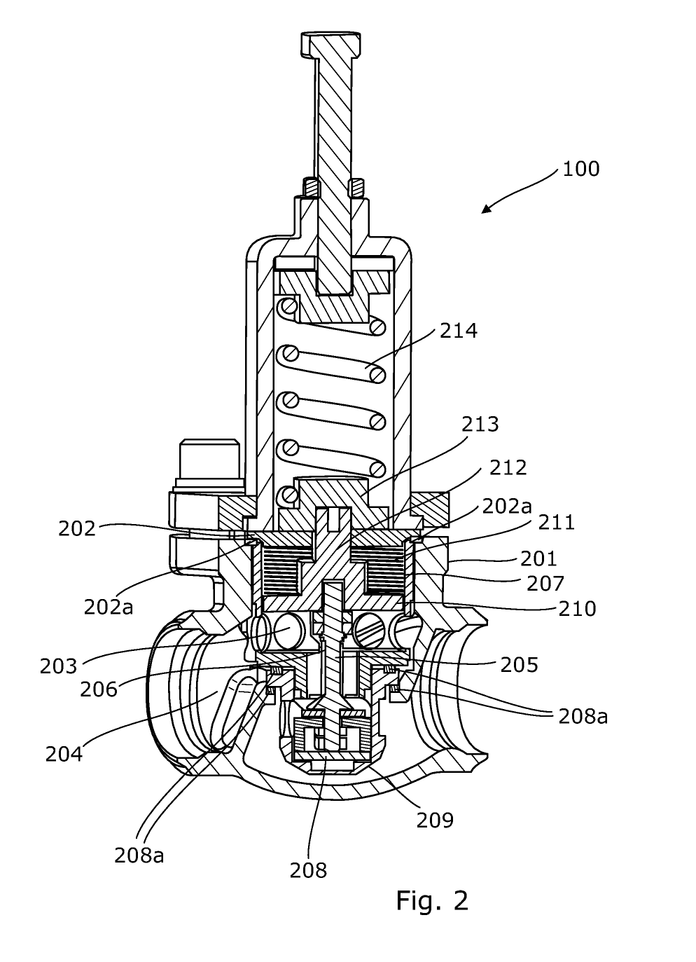

Referring to FIG. 2 herein, there is illustrated a cutaway view of the pressure build-up valve, in accordance with a preferred embodiment of the present invention. As illustrated the valve 100 comprises a valve body 201 having its interior divided by a transverse partition 202, a pressure chamber 203 and a relief chamber 204. Preferably, the valve body 201 is machine finished stainless steel.

An elongate valve member 205 extends through a central aperture 206 of the pressure chamber housing 207 to interact with a guide piston 208 housed within a bottom piston guide 209. Preferably, the pressure chamber housing is stainless steel; the guide piston is hi-tech brass and the bottom piston guide is phosphor bronze. Guide piston 208, through elongate valve member 205 engages with a complementary valve seating 210 carried by one end of a resilient biasing means, in this embodiment a compression spring bellows 211. Guide piston 208 is secured to valve seating 210 by PTFE seals (208a). The opposite end of the bellows 211 is secured to transverse partition 202 via a PTFE seal (202a). A second elongate valve member 212 extends from the valve seating 210, above the pressure chamber housing 207 to engage with the valve seat 213 of a further resilient biasing means in the form of a compression spring 214, which operates as a pressure setting spring, to adjust the pressure at which the valve operates. Preferably the valve seats 210 and 212 are hi-tech brass.

In the preferred embodiment of the invention, bellows 211 has a specifically designed spring rate within a range of 30-41 N/mm and the compression spring 214 and bellows 211 are arranged in series but are configured to operate in parallel. The predetermined spring rate and the parallel interactions of the spring 214 and bellows 211 allow a very low spring rate for the pressure setting spring 214 to be selected, thus allowing a smaller pressure sensing area. For example, in the preferred embodiment the valve diameter is 46 mm compared to a similar marketed product which has a diameter of 286 mm. Thus, the pressure build-up valve delivers increased sensitivity in combination with a reduced valve size.

Preferably, the compression spring 214 is stainless steel and the bellows 211 comprises a stainless steel subassembly.

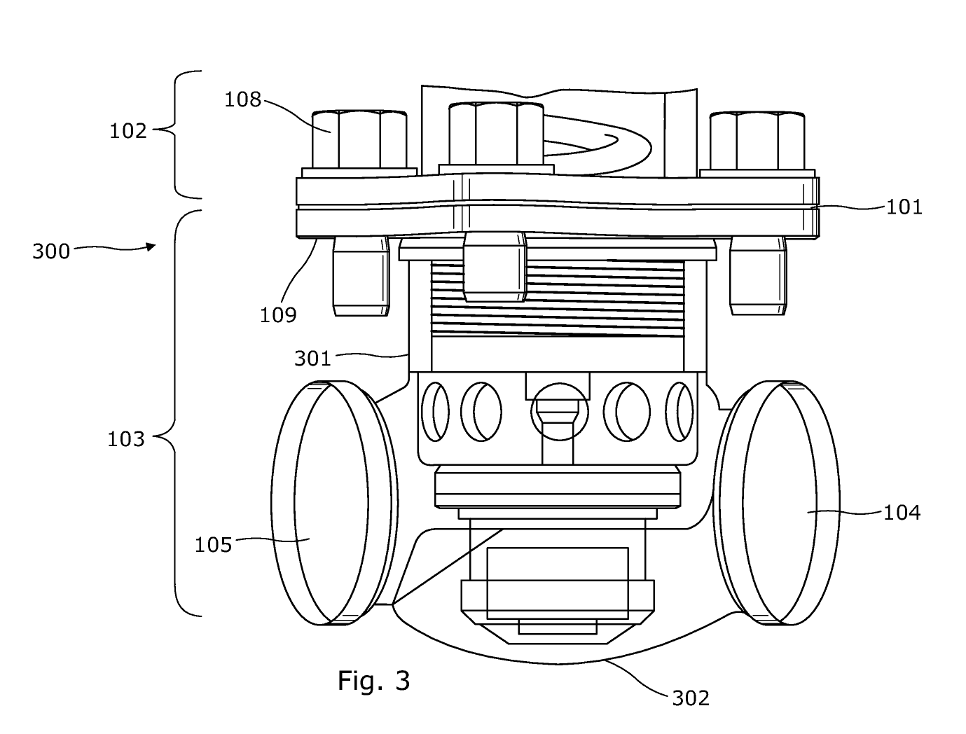

Referring to FIG. 3 herein there is illustrated an enlarged perspective view of the lower portion of the pressure build-up valve 300 in accordance with a preferred embodiment of the present invention, showing internal components of the valve. As illustrated threaded bolts 108, extend longitudinally through apertures 109, to connect the upper 102 part and lower part 103 of the valve. The lower part of the valve 103 has a substantially cylindrical shaped main body 301, with a domed base 302, said body 301 extending bi-directionally into two substantially symmetrical cylindrical openings, which form the valve inlet 104 and outlet 105, each having a standard butt weld end, allowing for easy welding on to flanges and direct welding onto pipes.

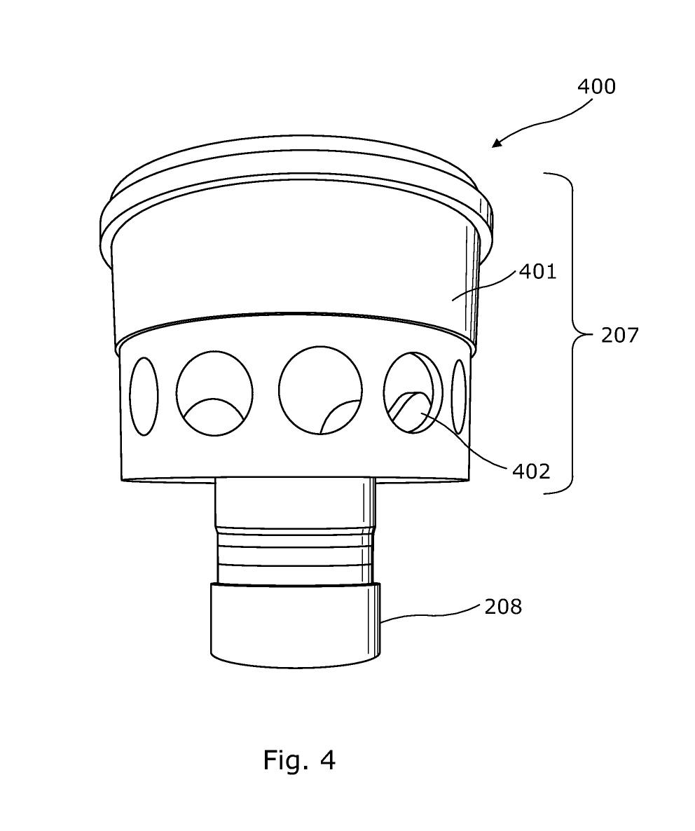

Referring to FIG. 4 herein there is illustrated an enlarged view 400 of pressure chamber housing 207 movably connected to guide piston 208, in accordance with a preferred embodiment of the present invention in an open position; said pressure chamber housing 207 comprises a substantially cylindrical body 401 having a plurality of cylindrical apertures 402 arranged circumferentially around the lower portion of the pressure chamber housing 207.

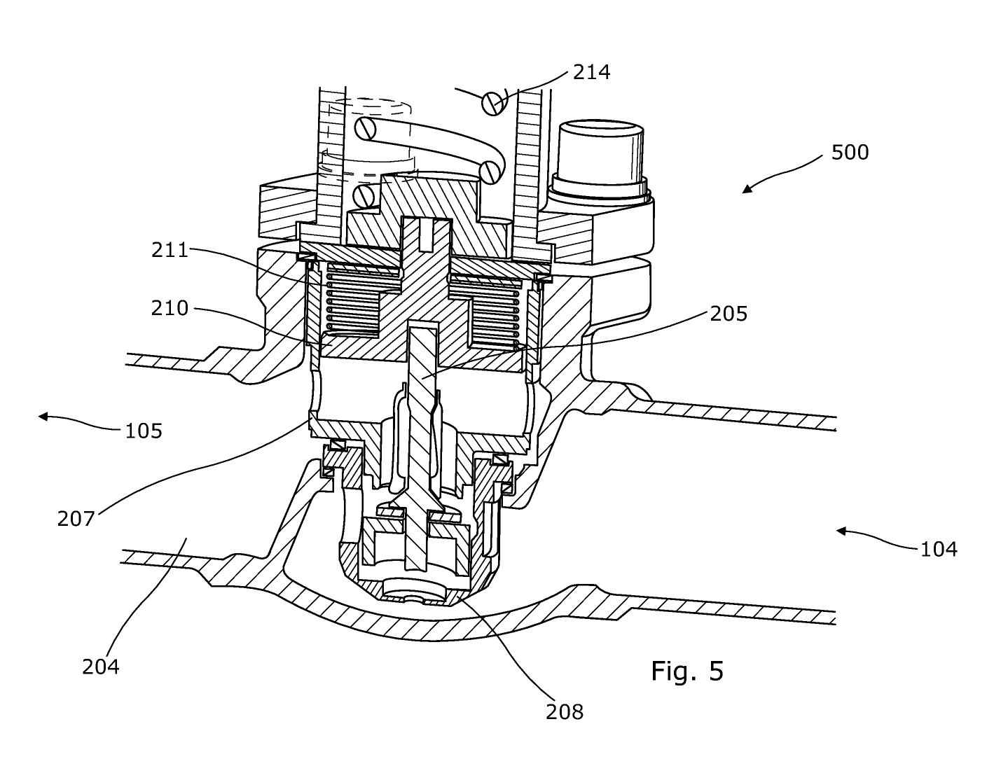

Referring to FIG. 5 herein there is illustrated a cross sectional cut away view of the lower portion of the pressure build-up valve, in accordance with a preferred embodiment of the present invention in an open position 500. As illustrated, the valve has an inlet 104 and an outlet 105. In response to a fall in pressure in the pressure build-up in the valve, the guide piston 208 is not maintained in a first, elevated position, thus relieving the pressure on the elongate valve member 205, and the complementary valve seating 210 carried by one end of a resilient biasing means, in this embodiment a pair of bellows 211. Said bellows 211 therefore no longer compresses spring 214 and the bellows and spring each maintain fully expanded positions and the valve is maintained in an open position.

The pressure build-up valve can be installed before or after a vaporizer coil such that the pressure sensing element is equally responsive to either liquid natural gas or gas with a similar pressure fall-off/proportional band being maintained. Considering an example in which the pressure build-up valve is installed on a trailer with a gravity driven pressure transfer system and utilizes an ambient air vaporizer located after the pressure build-up valve in the open position, fluid passes from the inlet 104 through the pressure build-up valve into an ambient air vaporizer, the vaporizer heats the liquid natural gas, flowing at a temperature of approximately −165° C., such that the liquid natural gas changes phase into a gas at operating conditions of approximately 65 psi and −139.7° C. The gas then flows into the top of the trailer causing the pressure to increase. When the pressure in the system reaches the pressure build-up valve set pressure, the valve will close, preventing the supply of the liquid natural gas to the vaporizer.

It is understood that the pressure build-up valve may be used with any type of vaporizer including but not limited to: open rack vaporizers, submerged combustion vaporizers and intermediate fluid vaporisers.

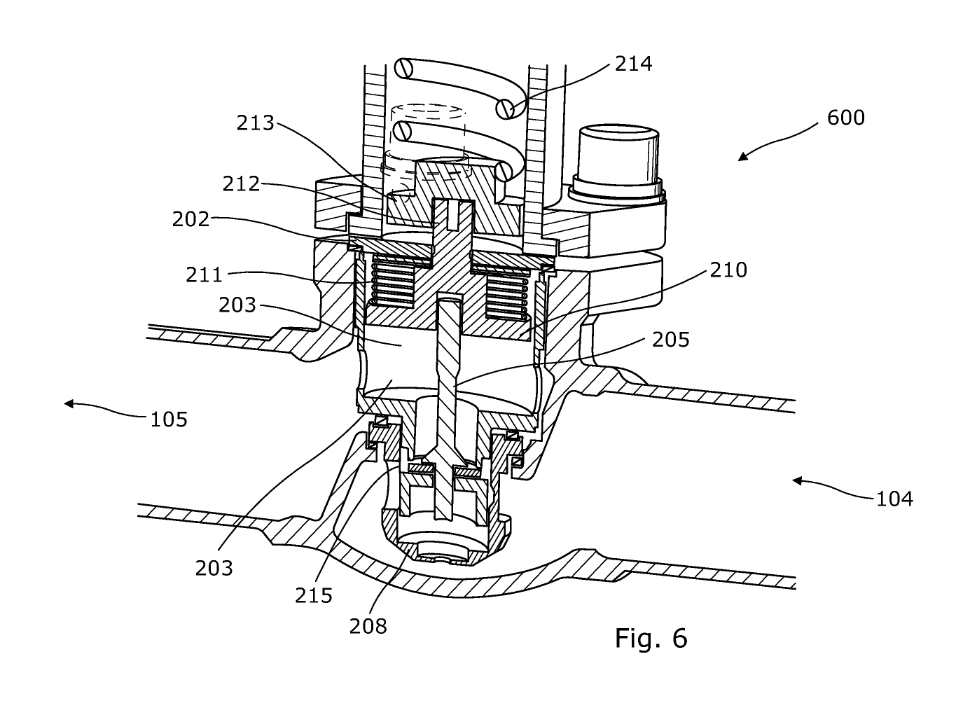

Referring to FIG. 6 herein, there is illustrated a cross sectional cut away view of the lower portion of the pressure build-up valve, in accordance with a preferred embodiment of the present invention in a closed position 600. As illustrated, the valve has an inlet 104 and an outlet 105. In response to an increase in pressure in the pressure build-up in the valve, the guide piston 208 is elevated in response to the pressure being exerted by fluid in the valve. The elevated guide piston 208 exerts pressure on the elongate valve member 205, and the complementary valve seating 210 carried by one end of a resilient biasing means, in this embodiment a pair of compression spring bellows 211. A second elongate valve member 212 extends from the valve seating 210 to engage with the valve seat 213 of a further resilient biasing means in the form of a spring 214. Both the spring 214 and the bellows 211 are compressed. Subsequently, the valve flow 215 is completely shut off and fluid cannot flow into the pressure chamber 203. When the pressure in the tank falls, the scenario in FIG. 5 will be re-established, re-opening the pressure valve.

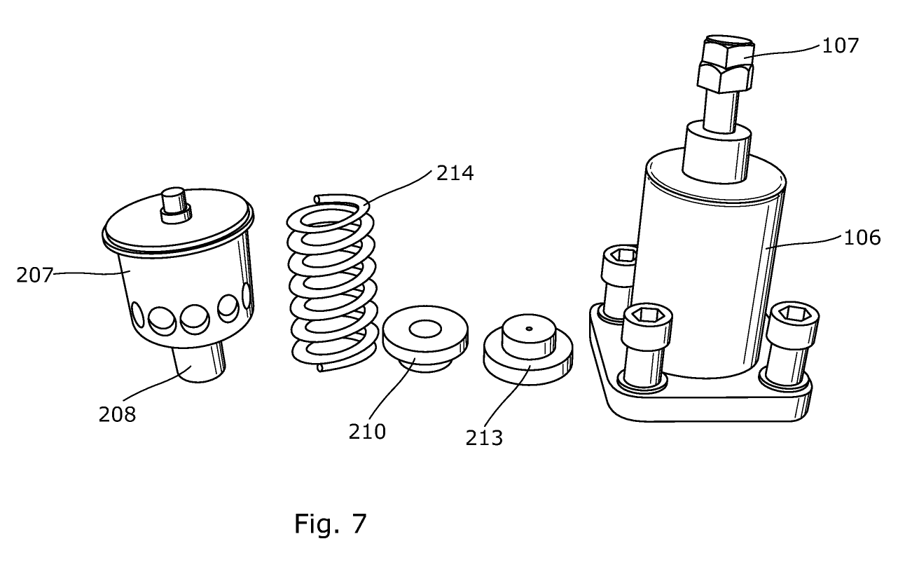

Referring to FIG. 7 herein, there is illustrated a view of some of the individual components of the pressure build up valve 700; said components including the pressure chamber housing 207 and guide piston 208, compression spring 214, a first 210 and second 213 valve seating and the pressure valve bonnet 106 with pressure adjusting screw 107.

1. A pressure build up valve comprising:
a valve body having an inlet and an outlet;
a valve bonnet;
an adjusting means mounted on said valve bonnet;
a pressure chamber housing;
a pressure chamber and a relief chamber;
a movable valve seat;
a piston;
a first resilient biasing means having a preset spring rate and located adjacent to said piston;
a second resilient biasing means having one end abutting said movable valve seat and an opposed end abutting the adjusting means;
said first resilient biasing means being located adjacent said second resilient biasing means;
said first and second resilient biasing means being arranged in series and configured to operate in parallel;
whereby, in response to a drop in pressure within the valve, said piston is lowered, thereby relieving pressure on the first resilient biasing means, causing it to expand; and the expanded first resilient biasing means biases the second resilient biasing means to open the valve and divert the flow of fluid from the pressure chamber into the relief chamber.

2. A pressure build up valve according to claim 1, whereby, in response to an increase in pressure within the valve, the guide piston is elevated by the liquid head within the valve compressing the first resilient biasing means;
the compressed first resilient biasing means biases the second resilient biasing means to close the valve and prevent the flow of fluid from the pressure chamber into the relief chamber.

3. A pressure build up valve according to claim 1, for use in cryogenic transportation trailer and storage tanks.

4. A pressure build up valve according to claim 1, for use with a closed loop liquefied natural gas (LNG) fluid control system.

5. A pressure build up valve according to claim 1, wherein the second resilient biasing means is a bellows.

6. A pressure build up valve according to claim 1, wherein said second resilient biasing means comprises a bellows having a preset spring rate in the range of 30 to 41 N/mm.

7. A pressure build up valve according to claim 1, wherein further comprising a pressure chamber housing, wherein said pressure chamber housing has an upper portion and a lower portion and a plurality of cylindrical apertures arranged circumferentially around said lower portion.

8. A pressure build-up valve according to claim 1, wherein said inlet and said outlet each have butt weld ends allowing for easy welding onto flanges and directly onto piping.

9. A pressure build up valve comprising:
a valve housing;
an inlet;
an outlet;
a first chamber in fluid communication with said inlet;
a second chamber in fluid communication with said outlet;
a movable valve operable between an open position in which said valve allows fluid communication between said first and second chambers and a second position in which said valve closes off fluid communication between said first and second chambers; and
a resilient biasing means for biasing said movable valve to said open position when a fluid pressure in said second chamber is lower than a fluid pressure in said first chamber;
wherein said resilient biasing means has a predetermined spring rate in the range 30N/mm to 40N/mm.

10. The pressure build up valve as claimed in claim 9, further comprising:
a pressure setting spring,
wherein said pressure setting spring, and said resilient biasing means, operate in series to urge said movable valve between said open and closed positions.
